(19) United States
(12) Patent Application Publication
(10) Pub. No.: US 2015/0192832 A1
(43) Pub. Date: Jul. 9, 2015

(54) LIQUID CRYSTAL DISPLAY PANEL

(71) Applicant: SHENZHEN CHINA STAR OPTOELECTRONICS TECHNOLOGY CO., LTD., Shenzhen, Guangdong (CN)

(72) Inventor: Zuomin Liao, Shenzhen (CN)

(21) Appl. No.: 14/240,390

(22) PCT Filed: Jan. 17, 2014
(86) PCT No.: PCT/CN2014/070760

§ 371 Date: Mar. 12, 2015

(30) Foreign Application Priority Data
Nov. 21, 2013 (CN) 201310595314.6

(51) Int. Cl. G02F 1/1362; G02F 1/1333; G02F 1/1343; G02F 1/1368

(52) U.S. Cl. CPC G02F 1/136209; G02F 1/1368; G02F 1/136286; G02F 1/136227; G02F 1/133345; G02F 1/13439; G02F 2001/136222; G02F 2001/136218

(57) ABSTRACT

The present disclosure relates to a liquid crystal display panel including an array substrate, the array substrate comprising: a substrate; a plurality of common electrode lines arranged on the substrate; a plurality of scan lines and data lines arranged on the substrate in a staggered manner to form a plurality of pixel areas; and a plurality of pixel units, each of which is arranged in a pixel area and includes a pixel electrode and a switching element, wherein the switching element is electrically connected to the scan line, the data line and the pixel electrode and is turned on under the action of a voltage signal of the scan line to transmit a voltage signal on the data line to the pixel electrode, so that the pixel electrode has a corresponding potential; and wherein in each pixel area, a shielding electrode electrically connected to the pixel electrode or the common electrode line covers the above of the scan line and the data line. The liquid crystal display panel of the present invention can reduce a phenomenon of light leakage and further have an improved aperture ratio of the pixel units.

### FIELD OF THE INVENTION

The present disclosure relates to the technical field of liquid crystal display, and particularly relates to a liquid crystal display panel for reducing light leakage.

### BACKGROUND OF THE INVENTION

An active thin film transistor liquid crystal display (TFT LCD) panel has become a mainstream product on the market with its excellent performance. One active TFT LCD panel generally consists of an array substrate, a color filter substrate and a liquid crystal layer. Wherein, a plurality of scan lines and data lines are arranged on the array substrate in a staggered manner to form a plurality of pixel areas, and one pixel unit is configured in each pixel area. Each pixel unit at least includes a thin film transistor (TFT) and a pixel electrode correspondingly connected with the TFT. The TFT, as a switching element for starting the pixel unit to operate, is connected to a scan line and a data line and thereby loads the voltage of a data signal to the corresponding pixel electrode under the drive of a scan signal, thus realizing display of image information.

Generally, a part of the area of the pixel electrode covers onto the scan line (such configuration is referred to as Cs on Gate), or covers onto a common electrode line of the array substrate (such configuration is referred to as Cs on Com), so as to form a storage capacitor Cst by coupling. The storage capacitor Cst functions to maintaining the voltage on the pixel electrode an as to keep high-quality picture display. Taking the pixel unit of the Cs on Com shown in FIG. 1 as an example, under the action of a scan signal voltage of a scan line 101, a thin film transistor 104 is turned on to transmit a data signal voltage on a data line 102 to a pixel electrode 103, and thus the pixel electrode 103 accordingly has a certain level of pixel potential. However, during this scanning and charging phase, the voltages on the scan line 101, the data line 102 and the pixel electrode 103 are different. In other words, the voltage differences between the scan line 101 and a common electrode 106, between the data line 102 and the common electrode 106, and between the pixel electrode 103 and the common electrode 106 are different from one another. Under the action of these voltages, liquid crystal molecules at the edge of the scan line 101, the edge of the data line 102 and the pixel electrode 103 correspondingly deflect at different angles. Due to these, the brightness at the edge of scan lines, the edge of data lines and the pixel display areas of the display panel are inconsistent, namely light leakage exists.

To avoid this light leakage, a black matrix for blocking leaked light is generally arranged on one side of the color filter substrate in the prior art. Moreover, to prevent light leakage caused by deflection of two glass sheets (the array substrate and the color filter substrate) of the liquid crystal display panel due to processing errors or external force, the black matrix is arranged to cover and exceed the data lines and the scan lines for a certain distance in design, which is bound to sacrifice the light transmission area of the pixel units, namely the aperture ratio of the pixel units is declined, so that rise of energy consumption of the whole display panel is indirectly caused. Accordingly, how to reduce light leakage on the premise that the aperture ratio is not affected and even improved is one research subject in the technical field of liquid crystal display. Inventors of the present disclosure, through repeated experimental research, propose a liquid crystal display panel capable of above-mentioned technical effects just based on practical experience in design and manufacturing of liquid crystal display panels and related professional knowledge.

### SUMMARY OF THE INVENTION

Based on the above-mentioned reasons, the objective of the present disclosure is to provide a liquid crystal display panel for effectively reducing a phenomenon of light leakage.

The present disclosure provides a liquid crystal display panel including an array substrate, wherein the array substrate comprises:

a substrate;

a plurality of common electrode lines arranged on the substrate;

a plurality of scan lines and data lines, arranged on the substrate in a staggered manner to form a plurality of pixel areas; and

a plurality of pixel units, each of which is arranged in a pixel area and includes:
a pixel electrode, and
a switching element, electrically connected to the scan line, the data line and the pixel electrode, and turned on under the action of a voltage signal of the scan line to transmit a voltage signal on the data line to the pixel electrode, so that the pixel electrode has a corresponding potential,

wherein, in each pixel area, a shielding electrode electrically connected to the pixel electrode or the common electrode line covers above the scan line and the data line.

According to one example of the present disclosure, a second insulating layer and an insulating protective layer are provided between the switching element and the pixel electrode, and the shielding electrode may be arranged between the second insulating layer and the insulating protective layer and electrically connected to the common electrode line.

Specifically, the shielding electrode which is made of a transparent conductive material covers the whole area of the second insulating layer except a through-hole of the second insulating layer.

Alternatively, the shielding electrode covers the whole area of the second insulating layer except the through-hole of the second insulating layer and an area below the pixel electrode.

Further, the shielding electrode may be made of a transparent or non-transparent conductive material.

According to another example of the present disclosure, the shielding electrode may be formed from the same transparent conductive layer with the pixel electrode by depositing, and the shielding electrode is electrically connected to the pixel electrode.

According to a further example, the shielding electrode may be formed from the same transparent conductive layer with the pixel electrode by depositing and photoetching, and the shielding electrode is disconnected from the pixel electrode but electrically connected to the common electrode line.

In the above-mentioned examples, an insulating flat layer may be provided, on the array substrate, between a second metal layer where the switching element situates and a transparent electrode conductive layer where the pixel electrode situates.

In the above-mentioned examples, a black matrix layer or a color filter layer may be provided, on the array substrate, between the second metal layer where the switching element situates and the transparent electrode conductive layer where the pixel electrode situates.

In addition, the above-mentioned liquid crystal display panel may also include a color filter substrate, on which RGB color blocking units corresponding to the pixel units of the array substrate are arranged but no black matrix.

Compared with the prior art, the beneficial effects of the present disclosure is in that, in each pixel area on the array substrate, the shielding electrode covers onto electric conductors (such as the data line and the scan line) having different potentials from the pixel electrode to prevent electric fields from being formed between the electric conductors and the common electrode line, so that light leakage in the pixel units due to liquid crystal electrons being subjected to disordered electric fields may be reduced. Further, because the shielding electrode of each pixel unit covers onto the data line and the scan line, the black matrix may be reduced in size and even eliminated. In this way, with light leakage eliminated, the aperture ratio of the pixel units may be improved at the same time.

Other features and advantages of the present disclosure will be illustrated in the following description, and are partially obvious from the description or understood through implementing the present disclosure. The objectives and other advantages of the present disclosure may be realized and obtained through the structures specified in the description, claims and accompanying drawings.

### BRIEF DESCRIPTION OF THE DRAWINGS

The accompanying drawings are provided for further understanding of the present disclosure, and constitute a part of the description for interpreting the present disclosure together with the examples of the present disclosure, rather than limiting the present disclosure. In the accompanying drawings:

FIG. 1 is a top view of a pixel unit of Cs on Com in the prior art;

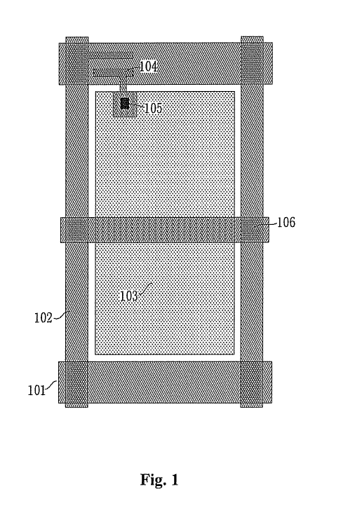

FIG. 2 is a top view of two pixel units with shielding electrodes according to the present disclosure;

FIG. 3 is a top view of another two pixel units with shielding electrodes according to the present disclosure;

FIG. 4 is a schematic diagram of sectional structure of pixel units of a first example of a liquid crystal display panel according to the present disclosure;

FIG. 5 is a schematic diagram of sectional structure, at B-B′ of FIG. 2, of pixel units of a second example of the liquid crystal display panel according to the present disclosure;

FIG. 6 is a schematic diagram of sectional structure, at C-C′ of FIG. 3, of pixel units of a third example of the liquid crystal display panel according to the present disclosure;

FIG. 7 is a schematic diagram of sectional structure, at B-B′ of FIG. 2, of pixel units of a fourth example of the liquid crystal display panel according to the present disclosure;

FIG. 8 is a schematic diagram of sectional structure, at C-C′ of FIG. 3, of pixel units of a fifth example of the liquid crystal display panel according to the present disclosure;

FIG. 9 is a schematic diagram of sectional structure, at B-B′ of FIG. 2, of pixel units of a sixth example of the liquid crystal display panel according to the present disclosure.

### DETAILED DESCRIPTION OF THE EMBODIMENTS

In a pixel unit of a liquid crystal display panel proposed in the present disclosure, a layer of shielding electrode covers onto a data line and a scan line which are electrically connected with said pixel unit and onto other electric conductors having different potentials from a pixel electrode of said pixel unit, to shield the data line, the scan line and a power line from the electric conductor to a common electrode. In this way, light leakage is reduced. Moreover, as a result of the shielding electrode, a black matrix may be reduced in size and even completely eliminated. By mean of these, with light leakage reduced, the aperture ratio of the pixel units is improved at the same time, thus reducing the energy consumption of the whole display device.

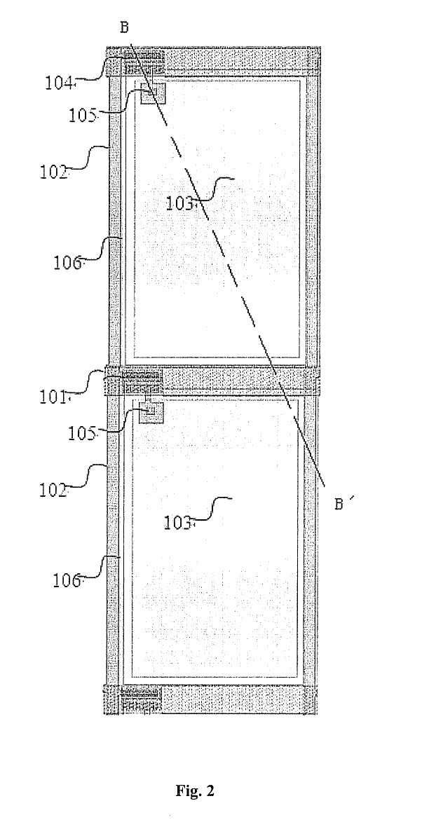

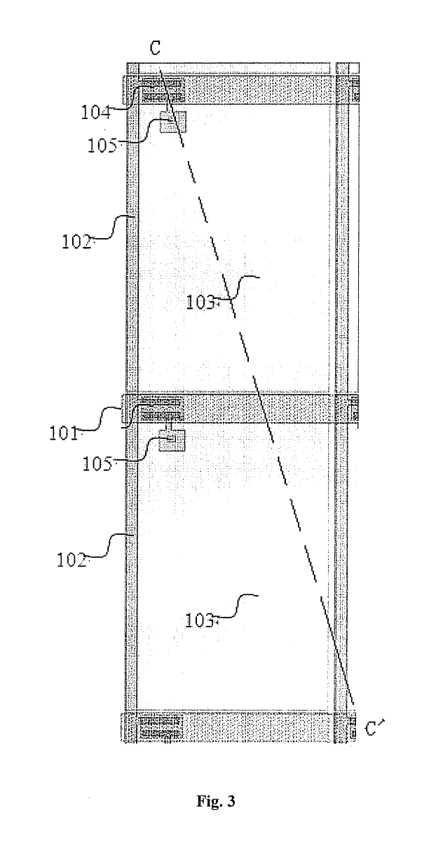

As shown in FIG. 2 and FIG. 3, specifically, in above-mentioned pixel unit of the liquid crystal display panel, said shielding electrode may be electrically connected to the common electrode to have a potential of the common electrode, or to the pixel electrode to have a potential of the pixel electrode. In FIG. 2 and FIG. 3, 101 is a scan line, 102 is a data line, 103 is a pixel electrode, 104 is a thin film transistor, 105 is a through-hole for implementing electric connection between the pixel electrode 103 and the thin film transistor 104, and 106 is a common electrode.

The embodiments of the present disclosure will be illustrated in detail below in conjunction with the accompanying drawings and examples, and thereby an implementation process using technical means of the present disclosure for solving the technical problems and achieving technical effects may be fully understood and implemented. It should be noted that respective examples of the present disclosure and various technical features in respective examples may be combined with one another as long as no conflicts exist, and all the formed technical solutions are within the protection scope of the present disclosure.

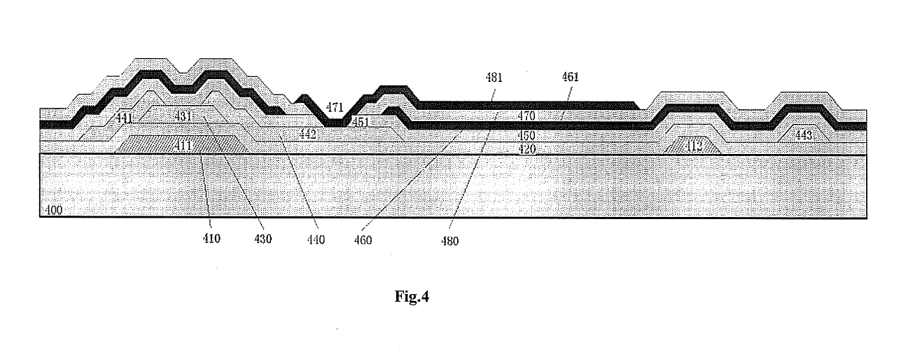

FIG. 4 shows a schematic diagram of sectional structure of pixel units of a first example of a liquid crystal display panel provided in the present disclosure. The liquid crystal display panel adopts the structure of “an array substrate-a liquid crystal layer-a color filter substrate” referred in the background. As known from FIG. 4, a substrate 400 of the array substrate includes a first metal layer 410, a first insulating layer 420, a semiconductor layer 430, a second metal layer 440, a second insulating layer 450, a conductive covering layer 460, an insulating protective layer 470 and a transparent conductive layer 480 which are successively deposited on the substrate 400. The specific detail is as follows:

1) The first metal layer 410 is deposited on the substrate 400 and forms, by means of photoetching patterning, the gate 411 of a thin film transistor, a scan line 412 and corresponding circuit connection thereof.

2) The first insulating layer 420 is deposited on the first metal layer 410 and configured to insulate the first metal layer 410 from the semiconductor layer 430 above the first insulating layer 420;

3) The semiconductor layer 430 is deposited on the first insulating layer 420 and forms, by means of ion doping and photoetching patterning, a conductive channel 431 of the thin film transistor;

4) The second metal layer 440 is deposited on the semiconductor layer 430 and forms, by means of photoetching patterning, the source 441 and drain 442 of the thin film transistor, a data line 443 and corresponding circuit connection thereof;

5) The second insulating layer 450 is deposited on the second metal layer 440 and configured to insulate the second metal layer 440 from the conductive covering layer 460 above the second insulating layer 450, and the second insulating layer 450 further forms a through-hole 451 by means of photoetching patterning to expose (a part or all of) the drain 442 of the thin film transistor;

6) The conductive covering layer 460 is deposited on the second insulating layer 450 and forms a shielding electrode 461 by means of photoetching patterning. In this example, the shielding electrode 461 covers all the area on the second insulating layer 450 except the through-hole 451, more specifically, it covers the corresponding areas of the scan line 412, the data line 443 and a pixel electrode 481, and the shielding electrode 461 is preferably electrically connected to a common electrode (not shown in the figure) of the liquid crystal display panel and thus has a potential of the common electrode;

7) The insulating protective layer 470 is deposited on the conductive covering layer 460 and configured to insulate the conductive covering layer 460 from the transparent conductive layer 480 above the insulating protective layer 470, and the insulating protective layer 470 further forms a corresponding through-hole 471 at the position of the through-hole 451 by means of photoetching patterning to expose (a part or all of) the drain 442 of the thin film transistor;

8) The transparent conductive layer 480 is deposited on the insulating protective layer 470 and forms, by means of photoetching patterning, the pixel electrode 481 which is electrically connected to the drain 442 of the thin film transistor via the through-holes 471 and 451.

In this example, since the shielding electrode 461 covers the corresponding area of the pixel electrode 481, namely covers the light transmission area of the pixel unit, the conductive covering layer 460 thereby needs to be manufactured by a transparent conductive material (such as indium tin oxide).

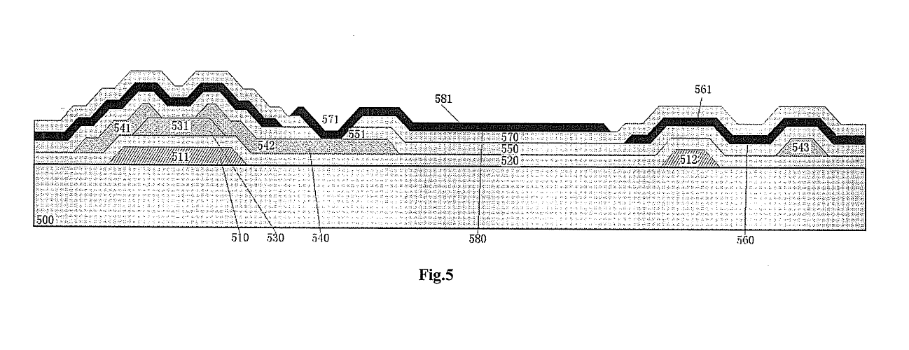

FIG. 5 shows a schematic diagram of sectional structure of pixel units of a second example of the liquid crystal display panel provided in the present disclosure. Specifically, the diagram shows a cross section of two pixel units shown in FIG. 2 at B-B′. As known from FIG. 5, a shielding electrode 561 covers all the area on a second insulating layer 550 except the corresponding areas of a through-hole 551 and a pixel electrode 581, more specifically, it covers the corresponding areas of a scan line 512 and a data line 543. In this example, because the shielding electrode 561 no longer covers the corresponding area of the pixel electrode 581, namely no longer covers the light transmission area of the pixel units, a conductive covering layer 560 thereby may be made of a non-transparent conductive material. In this example, it is preferable that the shielding electrode 561 is electrically connected to the common electrode (not shown in the figure) of the liquid crystal display panel and thus has a potential of the common electrode.

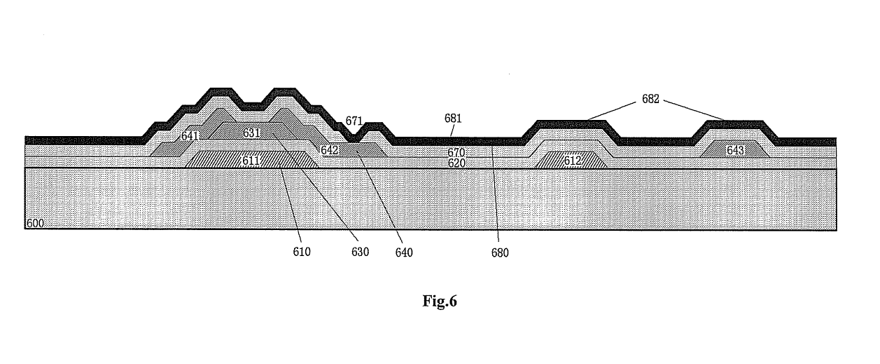

FIG. 6 shows a schematic diagram of sectional structure of pixel units of a third example of the liquid crystal display panel provided in the present disclosure. Specifically, the diagram shows a cross section of two pixel units shown in FIG. 3 at C-C′. Different from the previous two examples, in this example, the shielding electrode is electrically connected to the pixel electrode and thus has a potential of the pixel electrode. As known from FIG. 6, a substrate 600 of the array substrate includes a first metal layer 610, a first insulating layer 620, a semiconductor layer 630, a second metal layer 640, an insulating protective layer 670, and a transparent conductive layer 680, which are successively deposited on the substrate 600. The specific details are as follows:

1) The first metal layer 610 is deposited on the substrate 600 and forms, by means of photoetching patterning, the gate 611 of a thin film transistor, a scan line 612 and corresponding circuit connection thereof;

2) The first insulating layer 620 is deposited on the first metal layer 610 and configured to insulate the first metal layer 610 from the semiconductor layer 630 above the first insulating layer 620;

3) The semiconductor layer 630 is deposited on the first insulating layer 620 and forms a conductive channel 631 of the thin film transistor by means of ion doping and photoetching patterning;

4) The second metal layer 640 is deposited on the semiconductor layer 630 and forms, by means of photoetching patterning, the source 641 and drain 642 of the thin film transistor, a data line 643 and corresponding circuit connection thereof;

5) The insulating protective layer 670 is deposited on the second metal layer 640 and configured to insulate the second metal layer 640 from the transparent conductive layer 680 above the insulating protective layer 670;

6) The transparent conductive layer 680 is deposited on the insulating protective layer 670 and may be directly used as a pixel electrode 681 and a shielding electrode 682 without photoetched, wherein the shielding electrode 682 covers above the scan line 612 and the data line 643 of the pixel unit, and the shielding electrode 682 has a same potential with the pixel electrode 681 because of connected with the pixel electrode 681 as a whole. Certainly, the probability of photoetching to the transparent conductive layer 680 is not excluded, and the same technical effect may be achieved as long as the shielding electrode 682 is maintained to be electrically connected to the pixel electrode 681 all the time.

In this example, both the shielding electrode 682 and the pixel electrode 681 belong to the transparent conductive layer 680 and do not need to be additionally disposed, thus the manufacturing process of such pixel unit is simpler and faster than that of the previous two examples.

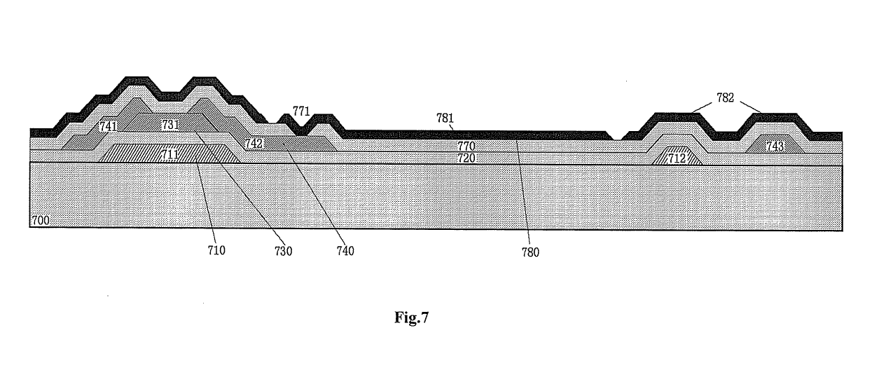

FIG. 7 shows a schematic diagram of a sectional structure of pixel units of a fourth example of the liquid crystal display panel provided in the present disclosure. Specifically, the diagram shows the sectional structure at B-B′ of FIG. 2. In the pixel unit shown in FIG. 6, since the pixel electrode 681 is connected with the shielding electrode 682 as a whole, the voltage on the pixel electrode 681 may be affected by the coupling effect between the shielding electrode 682 and the scan line 612 as well as between the shielding electrode 682 and the data line 643. In view of this, in this example, the structure of the pixel unit shown in FIG. 6 is further improved, that is, after a transparent conductive layer 780 is deposited on an insulating protective layer 770, the connection between a pixel electrode 781 and a shielding electrode 782 in the transparent conductive layer 780 is cut off by means of photoetching or laser. At this moment, the shielding electrode 782 needs to be electrically connected to the common electrode (not shown in the figure) and thus has a potential of the common electrode.

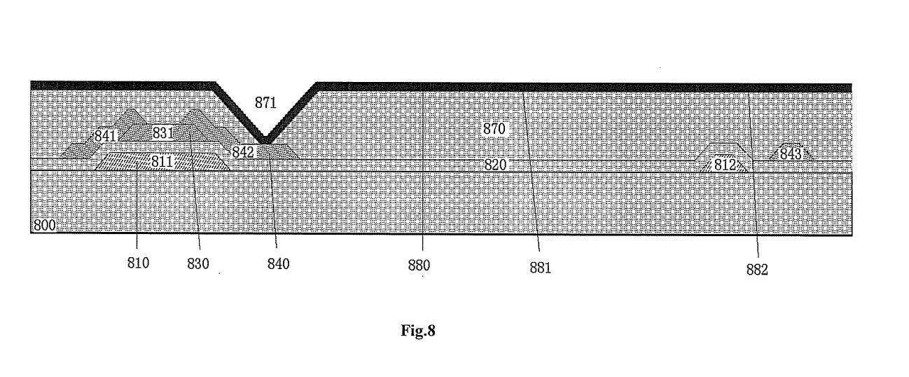

FIG. 8 shows a schematic diagram of sectional structure of pixel units of a fifth example of the liquid crystal display panel provided in the present disclosure, specifically, the diagram shows the sectional structure at C-C′ of FIG. 3. As known from FIG. 8, a substrate 800 of the array substrate includes a first metal layer 810, a first insulating layer 820, a semiconductor layer 830, a second metal layer 840, a flat protective layer 870, and a transparent conductive layer 880, which are successively deposited on the substrate 800. The specific detail is as follows:

1) The first metal layer 810 is deposited on the substrate 800 and forms, by means of photoetching patterning, the gate 811 of a thin film transistor, a scan line 812 and corresponding circuit connection thereof;

2) The first insulating layer 820 is deposited on the first metal layer 810 and configured to insulate the first metal layer 810 from the semiconductor layer 830 above the first insulating layer 820;

3) The semiconductor layer 830 is deposited on the first insulating layer 820 and forms a conductive channel 831 of the thin film transistor by means of ion doping and photoetching patterning;

4) The second metal layer 840 is deposited on the semiconductor layer 830 and forms, by means of photoetching patterning, the source 841 and drain 842 of the thin film transistor, a data line 843 and corresponding circuit connection thereof;

5) The flat protective layer 870 is deposited on the second metal layer 840 and configured to insulate the second metal layer 840 from the transparent conductive layer 880 above the flat protective layer 870. Meanwhile, the flat protective layer 870 further forms a through-hole 871 by means of photoetching patterning to expose (a part or all of) the drain 842 of the thin film transistor;

6) The transparent conductive layer 880 is deposited on the flat protective layer 870 and may be directly used as a pixel electrode 881 and a shielding electrode 882 without photoetched, wherein the pixel electrode 881 is electrically connected to the drain 842 of the thin film transistor via the through-hole 871, and the shielding electrode 882 covers above the scan line 812 and the data line 843 of the pixel unit. Meanwhile, the shielding electrode 882 has a same potential with the pixel electrode 881 because of connected with the pixel electrode 881 as a whole. Certainly, the probability of photoetching to the transparent conductive layer 880 is not excluded, and the same technical effect may be achieved as long as the shielding electrode 882 is maintained to be electrically connected to the pixel electrode 881 all the time.

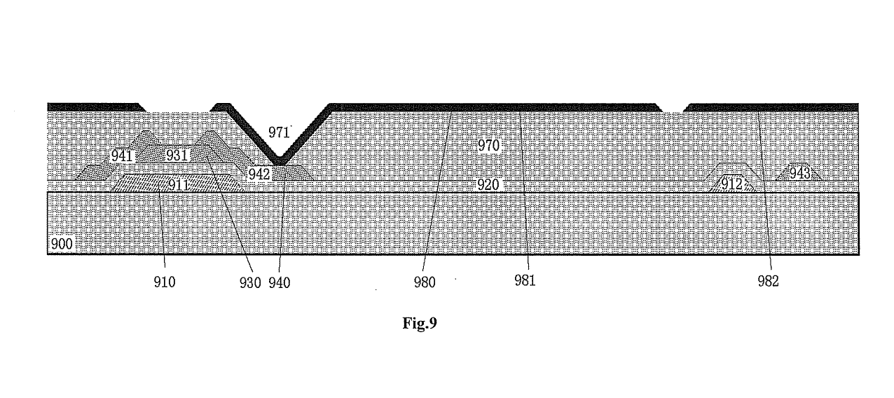

FIG. 9 shows a schematic diagram of sectional structure of a pixel unit of a sixth example of the liquid crystal display panel provided in the present disclosure, specifically, the diagram shows the sectional structure at B-B′ of FIG. 2. In the pixel unit shown in FIG. 8, since the pixel electrode 881 is connected with the shielding electrode 882 as a whole, the voltage on the pixel electrode 881 thereby may be affected by the coupling effect between the shielding electrode 882 and the scan line 812 as well as between the shielding electrode 882 and the data line 843. In view of this, the structure of the pixel unit shown in FIG. 8 is further improved in this example, that is, after a transparent conductive layer 980 is deposited on a flat protective layer 970, the connection between a pixel electrode 981 and a shielding electrode 982 in the transparent conductive layer 980 is cut off by means of photoetching or laser. At this moment, the shielding electrode 982 needs to be electrically connected to the common electrode (not shown in the figure) and thus has a potential of the common electrode.

In above examples shown in FIG. 8 and FIG. 9, the flat protective layer of the pixel unit may be replaced by a black matrix layer or a color filter layer, and correspondingly, the liquid crystal display panel is not the mentioned structure “an array substrate-a liquid crystal layer-a color filter substrate” any more but a COA (Color filter On Array) or BOA (Black matrix On Array) structure. Because the COA structure and the BOA structure both belong to the prior art and out of the protected concern of the present disclosure, they will not be described herein.

In the liquid crystal display panel of the examples shown in FIG. 4 to FIG. 9, the shielding electrode of each pixel unit covers onto the data line and the scan line, so that the black matrix may be reduced in size and even completely eliminated. Accordingly, with light leakage eliminated, the aperture ratio of the pixel unit may be improved at the same time. Moreover, the present disclosure also relates to a liquid crystal display panel including a color filter substrate, on which RGB color blocking units corresponding to the pixel units of the array substrate are arranged but not the black matrix.

It should be noted that although the embodiments disclosed in the present disclosure are described above, the foregoing contents are merely the embodiments for facilitating understanding the present disclosure, rather than limiting the present disclosure. The structures of pixel units designed by liquid crystal panel manufacturers are different and present as various variant. For example, a plurality of thin film transistors may be arranged in each pixel unit of a large-sized liquid crystal display panel in order to compensate color offset due to large view angle in a multi-domain display manner. Therefore, any variations or substitutions readily conceivable by anyone familiar with this art within the disclosed technical scope of the present disclosure, or any modifications and variations made to the embodiments and details should be incorporated in the protection scope of the present disclosure.

1. A liquid crystal display panel including an array substrate, the array substrate comprises:
a substrate;
a plurality of common electrode lines arranged on the substrate;
a plurality of scan lines and data lines, arranged on the substrate in a staggered manner to form a plurality of pixel areas; and
a plurality of pixel units, each of which is arranged in a pixel area and includes:
a pixel electrode, and
a switching element, electrically connected to the scan line, the data line and the pixel electrode, and turned on under the action of a voltage signal of the scan line to transmitting a voltage signal on the data line to the pixel electrode, so that the pixel electrode has a corresponding potential,
wherein, in each pixel area, a shielding electrode electrically connected to the pixel electrode or the common electrode line covers above the scan line and the data line.

2. The liquid crystal display panel of claim 1, wherein,
a second insulating layer and an insulating protective layer are provided between the switching element and the pixel electrode, and the shielding electrode is arranged between the second insulating layer and the insulating protective layer, and electrically connected to the common electrode line.

3. The liquid crystal display panel of claim 2, wherein,
the shielding electrode, which is made of a transparent conductive material, covers the whole area of the second insulating layer except a through-hole of the second insulating layer.

4. The liquid crystal display panel of claim 2, wherein,
the shielding electrode covers the whole area of the second insulating layer except the through-hole of the second insulating layer and an area below the pixel electrode.

5. The liquid crystal display panel of claim 4, wherein,
the shielding electrode is made of a transparent or non-transparent conductive material.

6. The liquid crystal display panel of claim 1, wherein,
the shielding electrode is formed from the same transparent conductive layer with the pixel electrode by means of depositing, and the shielding electrode is electrically connected to the pixel electrode.

7. The liquid crystal display panel of claim 6, wherein,
the shielding electrode is formed from the same transparent conductive layer with the pixel electrode by means of depositing and photoetching, and the shielding electrode is disconnected from the pixel electrode but electrically connected to the common electrode line.

8. The liquid crystal display panel of claim 6, wherein,
an insulating flat layer is provided, on the array substrate, between a second metal layer where the switching element situates and a transparent electrode conductive layer where the pixel electrode situates.

9. The liquid crystal display panel of claim 7, wherein,
an insulating flat layer is provided, on the array substrate, between a second metal layer where the switching element situates and a transparent electrode conductive layer where the pixel electrode situates.

10. The liquid crystal display panel of claim 6, wherein,
a black matrix layer or a color filter layer is provided, on the array substrate, between the second metal layer where the switching element situates and the transparent electrode conductive layer where the pixel electrode situates.

11. The liquid crystal display panel of claim 7, wherein,
a black matrix layer or a color filter layer is provided, on the array substrate, between the second metal layer where the switching element situates and the transparent electrode conductive layer where the pixel electrode situates.

12. The liquid crystal display panel of claim 1, wherein further including a color filter substrate, on which RGB color blocking units corresponding to the pixel units of the array substrate are arranged but no black matrix.

13. The liquid crystal display panel of claim 2, wherein further including a color filter substrate, on which RGB color blocking units corresponding to the pixel units of the array substrate are arranged but no black matrix.

14. The liquid crystal display panel of claim 3, wherein further including a color filter substrate, on which RGB color blocking units corresponding to the pixel units of the array substrate are arranged but no black matrix.

15. The liquid crystal display panel of claim 4, wherein further including a color filter substrate, on which RGB color blocking units corresponding to the pixel units of the array substrate are arranged but no black matrix.

16. The liquid crystal display panel of claim 5, wherein further including a color filter substrate, on which RGB color blocking units corresponding to the pixel units of the array substrate are arranged but no black matrix.

17. The liquid crystal display panel of claim 6, wherein further including a color filter substrate, on which RGB color blocking units corresponding to the pixel units of the array substrate are arranged but no black matrix.

18. The liquid crystal display panel of claim 7, wherein further including a color filter substrate, on which RGB color blocking units corresponding to the pixel units of the array substrate are arranged but no black matrix.
